(19) United States
(12) Patent Application Publication
(10) Pub. No.: US 2021/0033052 A1
(43) Pub. Date: Feb. 4, 2021

(54) Device and Method for Supplying Water Into a High-Pressure Fuel Pump of an Internal Combustion Engine Provided in a Motor Vehicle

(71) Applicant: Bayerische Motoren Werke Aktiengesellschaft, Muenchen (DE)

(72) Inventors: Martin BOEHM, Poecking (DE); Andreas BRUHN, Puchheim (DE); Andre LINDENLAUB, Muenchen (DE); Dirk LINSE, Muenchen (DE); Andreas SANDMAIR, Ried (DE)

(21) Appl. No.: 16/966,659

(22) PCT Filed: Jan. 22, 2019
(86) PCT No.: PCT/EP2019/051452

§ 371 Date: Jul. 31, 2020

(30) Foreign Application Priority Data
Feb. 1, 2018 (DE) 10 2018 201 565.1

(51) Int. Cl. F02M 43/02; F02M 63/02

(52) U.S. Cl. CPC F02M 43/02; F02M 37/04; F02M 63/0225

(57) ABSTRACT

A device supplies water into a high-pressure fuel pump of a motor vehicle internal combustion engine, wherein the water is admixed to the fuel in the inlet region of the high-pressure fuel pump in a controlled manner by a metering valve, and wherein the device is designed to guide the water at least from a part of a supply line back to the storage container. When viewed in the flow direction from the storage container to the high-pressure fuel pump, a shut-off valve is provided in the supply line upstream of the metering valve, and the supply line is designed to elastically deformably change its volume in a line section positioned between the valves. In an operating method, wherein, after the parking of the motor vehicle in conditions that make it possible for the liquid that is at risk of freezing to freeze, and/or after delivery of the liquid to the high-pressure fuel pump, and with a suitably adjusted upstream fluid pressure, the metering valve is opened and remains open until a portion of the fluid in the section of the supply line leading from the metering valve to the high-pressure fuel pump flows out through the metering valve.

### BACKGROUND AND SUMMARY OF THE INVENTION

The invention relates to a device for supplying a liquid at risk of freezing, in particular water, into a high-pressure fuel pump of an internal combustion engine provided in particular in a motor vehicle, wherein the liquid at risk of freezing is admixed as required in a controlled manner by a metering valve with the fuel present in the inlet region of the high-pressure fuel pump at a certain pressure, and wherein the device is designed to return the liquid at risk of freezing at least from a portion of a supply line, through which the liquid passes from a reservoir to the high-pressure fuel pump, to the reservoir. The invention also relates to an operating method for a device for supplying water into a high-pressure fuel pump of an internal combustion engine provided in particular in a motor vehicle.

In the future, there will be increasingly more vehicle internal combustion engines in which water is admixed with the combustion of fuel at least in certain operating points. This water is preferably removed from a carried-along reservoir and delivered by means of a delivery device to at least one injection valve which injects a certain amount of water for example into the air intake system of the internal combustion engine or into (in each case) one of its combustion chambers. This can occur by virtue of the fact that the already present fuel injection valves assigned to the individual combustion chambers of the (typically multicylinder) internal combustion engine can also be used to inject the desired water, to be precise in the form of an emulsion which is formed in a high-pressure fuel pump to which, for compression, there is supplied not only the fuel but also, in dependence on the respective operating point of the internal combustion engine, water. The present invention relates to such a last-mentioned system for the requirement-dependent or as required supply of water into one or the combustion chambers of an internal combustion engine.

If a motor vehicle equipped with such a system or such an internal combustion engine is parked after operation at cold times of year for a time period of a number of hours, water which is still situated in a supply line leading to the high-pressure fuel pump could freeze. Then, after reactivation of the internal combustion engine, no supply of water to its combustion chambers would be possible for a relatively long timespan. The supply line itself could also be damaged as a result of ice pressure. By contrast, small water fractions in an—if at all present—emulsion of fuel and some water are harmless, since there is no risk of freezing here at the usual negative temperatures.

In order to solve the aforementioned problem, it is known that, when or after parking the vehicle or deactivating the internal combustion engine, at least the water still present in a certain region of the supply line can at least as required (namely, where appropriate, in dependence on the ambient temperature) be returned in a suitable manner into a reservoir, from which, during operation of the internal combustion engine, a delivery device delivers water to the high-pressure fuel pump dependent on requirement. For example, the delivery device just mentioned can be operated with reversed delivery direction for this return.

However, it is not possible for the supply line to be completely emptied right up to the high-pressure fuel pump since here firstly the risk would exist that fuel, which in any case initially prevails under a certain excess pressure (in relation to ambient pressure) at the inlet region of the high-pressure fuel pump, would also pass back into the reservoir, although it is not designed for this purpose. Secondly, upon refilling the supply line with water, the air previously contained in this line would pass into the high-pressure fuel pump, which must not happen under any circumstances. Now, it is possible to provide a valve in the supply line at a certain distance upstream of the high-pressure fuel pump, the valve being closed prior to the emptying of the supply line, that is to say at a time before a return of water from the supply line into the reservoir, such a valve as a so-called metering valve, by means of which the amount of water supplied to the high-pressure fuel pump can be determined, already being (at least internal) prior art. However, after emptying of that section of the supply line leading to this valve or metering valve, an appreciable pressure difference of different media prevails on both sides of this valve, namely air under ambient pressure in that section of the supply line leading to the metering valve, and, in that section leading from the metering valve to the high-pressure fuel pump, water having substantially the same pressure at which the fuel at the inlet region of the high-pressure fuel pump prevails, namely initially (that is to say directly after deactivating the internal combustion engine) a pressure of approximately 5 bar to 6 bar. This pressure difference, in particular also of different media, results even after a relatively short time to leakages, that is to say water would pass through the metering valve into the actually emptied section of the supply line. This is unwanted.

Providing a remedial measure for this outlined problem is the object of the present invention.

This object is achieved in that, as viewed in the flow direction from the reservoir toward the high-pressure fuel pump, a shut-off valve arranged upstream of the metering valve is provided in the supply line, and in that the supply line is designed to elastically deformably change its volume with a line section situated between these two valves.

For an operating method, the object is achieved in that, after parking the motor vehicle, at least under conditions which make it possible for liquid at risk of freezing to freeze, and/or subsequent to a delivery of this liquid to the high-pressure fuel pump, the metering valve, with liquid pressure suitably set upstream thereof, is opened for so long that some of the liquid situated in the section of the supply line leading from the metering valve to the high-pressure fuel pump flows off through the metering valve.

It is proposed first of all that the already present metering valve has a further valve functionally arranged upstream thereof that is designated as a shut-off valve, more precisely as an engine shut-off valve, since it is situated relatively close to the internal combustion engine, that is to say the motor (drive motor) of the motor vehicle. With such a series connection of two valves, the probability of a leakage with the internal combustion engine deactivated (or with the motor vehicle parked) is minimized, since small amounts of liquid which pass through the metering valve into the line section (of the supply line) between the metering valve and the shut-off valve are in any case held back by the shut-off valve. However, with the motor vehicle parked in cold surroundings, the water situated in this line section could freeze, with the result that this line section would be endangered and could be destroyed by the ice pressure then forming. To prevent this from happening, the line section of the supply line (between shut-off valve and metering valve) is designed in such a way that it can increase its volume to a certain extent required for the volume increase of the water situated therein during ice formation, to be precise elastically, that is to say that a volume of this line section increased on account of ice formation is reduced again to its original size after the ice has melted. A particularly advantageous embodiment for this purpose will be described at a later point; first of all, however, an operating method which can be carried out in particular with a device described thus far in a particular advantageous manner will be described.

Accordingly, when a return of liquid or water at risk of freezing into the reservoir (in particular owing to standstill of the motor vehicle) is intended, a certain liquid pressure can be built up first of all in the line section of the supply line between the engine shut-off valve and the already closed metering valve, so that, after closing the shut-off valve, a liquid excess pressure in relation to ambient pressure is present in this line section, thereby optimally or securely preventing possible leakages over the metering valve. Although a pressure drop then exists between the two sides of the shut-off valve, a simple shut-off valve, which can assume only an open position and a closed position, is able to shutoff tight substantially more securely than is the case for a metering valve which can either assume any desired intermediate positions or operates in cyclic operation.

However, it is particularly advantageous if the liquid pressure produced as described above in the line section lies in terms of magnitude below the fuel pressure prevailing at the inlet region of the high-pressure fuel pump. It is then namely possible, in particular in conjunction with an emptying of the supply line in a portion upstream (that is to say as viewed from the reservoir in the direction of the engine shut-off valve) of the engine shut-off valve—although expressly not restricted to such an emptying—for the metering valve to be briefly opened after this shut-off valve has closed. Consequently, by virtue of the pressure drop between the fuel pressure prevailing at the inlet region of the high-pressure fuel pump and the water pressure prevailing in the line section, a certain amount of water passes through the opened metering valve into the line section. As a result thereof, an interface between water and fuel that is present in that section of the supply line leading from the metering valve to the high-pressure fuel pump is displaced by a certain length toward the metering valve. However, this interface, which will be explained in the following paragraph, should still remain at a distance from the metering valve, which is ensured by prompt closing of the metering valve. If then the water in this section of the supply line freezes after a certain time, the volume increase resulting from the ice formation can be simply accommodated by displacing some fuel, it being the case that, at the time of the previously described closing of the metering valve, the interface should be spaced apart from the high-pressure fuel pump or its inlet region to such an extent that, after ice formation in the inlet region of the high-pressure fuel pump, fuel (and no water or ice) is still present.

With a brief description now of the aforementioned interface, the supply of water into the inlet region of the high-pressure fuel pump can be configured in a relatively simple manner, namely in that—expressed in a simplified manner—the supply line for water opens into the fuel line via a T-piece, preferably only shortly before the transition of the fuel line into the high-pressure fuel pump. Consequently, the water from the supply line impinges the fuel in the fuel line, but, as is known, these two liquids (and in particular in the case of petrol) do not mix with one another, resulting in the formation of an interface between fuel and water. The arrangement of the aforementioned lines and in particular also the level of the pressure to which the two present liquids (water and fuel) are subjected is such that, in the case that no water is intended to be injected into the combustion chambers of the internal combustion engine, the interface is situated in that section of the water supply line leading from the metering valve to the high-pressure fuel pump. If, by contrast, water is intended to be injected together with fuel, the pressure of the water brought up through the then open metering valve is suitably increased until its lies slightly above the fuel pressure (prevailing at the inlet region of the high-pressure fuel pump).

It has been described further above—prior to the explanation of the interface—how it is ensured that a freezing of the water situated in the section of the supply line leading from the metering valve to the high-pressure fuel pump causes no damage. In particular, it is necessary here to avoid any risk of damage to the high-pressure fuel pump. It should be expressly pointed out here that this discharge of water (and the thus associated displacement of the interface between water and fuel) brought about by brief opening of the metering valve in no way requires a shut-off valve arranged upstream of the metering valve. If, however, such a shut-off valve—as has been explained—is present in particular on account of possible tightness problems of the metering valve, a freezing of the water situated in the line section between the metering valve and the shut-off valve is also unproblematic, since for this purpose the already briefly mentioned embodiment with elastically deformable volume change is provided, which will be explained further at a later point. Moreover, for reactivation of the internal combustion engine, the section, mentioned further above, of the supply line between the metering valve and high-pressure fuel pump, which is typically very short in the actual installed state in a motor vehicle, can be configured to be heatable in a simple manner, with the result that water which has frozen in this section simply thaws. For this purpose, the waste heat of the internal combustion engine can already suffice after a short operating period.

Returning once again to the already described discharge of a small amount of water from the section of the supply line leading from the metering valve to the high-pressure fuel pump, such a partial removal of water is advantageous not only with respect to ice formation, that is to say a possible freezing of the water, but can also generally be carried out subsequent to a delivery of water to the high-pressure fuel pump. If namely a relatively small amount of water is situated in the section of the supply line (between the metering valve and the high-pressure fuel pump), just a relatively low amount of water experiences, as considered over time, a certain contamination from the fuel coming into contact with this water at the already explained interface. Although no mixing of water and fuel takes place, it is namely possible for example for alcohols and salts from the fuel to diffuse over into the water via this the interface. The less water then situated in the aforementioned section of the supply line, the less water will be contaminated in such a way. Of course, however, there should always be a small amount of water adjacent to the metering valve in this section and, of course, in order to be able to remove some of the water from this section via the metering valve, a water pressure has to be set beforehand in the line section between the shut-off valve and the metering valve that in terms of magnitude lies below the fuel pressure prevailing in the inlet region of the high-pressure fuel pump. For this purpose, the delivery device for the water can be suitably operated.

As will be discussed below for the line section between the shut-off valve and the metering valve, the elastic deformability for volume change can be formed by a wall section (of the line section) which can be displaced against the force of a spring element. To ensure uniform elasticity even over a long time period, the wall-forming material as such is preferably not elastically deformable; rather, a regionally delimited part is provided in the wall of the line section, the wall being intrinsically rigid and formed for example of a metal material, and can be displaced for example like a piston in a surrounding cylinder in order to create additional volume for the ice formation. For this purpose, the line section can be configured in such a way that, as viewed over the time course of the freezing of the water situated therein, the freezing at the point where the volume which can be changed by elastic deformation—that is to say for example the aforementioned displaceable piston—is provided occurs last. Such a so-called targeted freezing (known in principle to a person skilled in the art) can be produced by locally suitably differently selected wall thicknesses of the line section. It is thus possible for the line section between the shut-off valve and the metering valve to be designed with respect to a targeted freezing in such a way that, by virtue of high wall thicknesses (of the wall of the line section) in a region producing the aforementioned elastic deformation, a freezing of liquid situated in this region occurs later in time than in other regions of this line section of the supply line.

At this point there should be mentioned yet a further advantage of the design of the line section with elastically deformable volume, namely that a pressure accumulator or volume accumulator is provided thereby to ensure the tightness of the metering valve, in particular with the internal combustion engine deactivated. As already stated further above, a liquid or water pressure is built up in the line section after deactivating the internal combustion engine that lies in the order of magnitude of the fuel pressure prevailing at first at the high-pressure fuel pump. (As has been stated, it is possible for this purpose for the metering valve to be briefly opened with the shut-off valve closed, whereupon water situated in the section of the supply line leading from the metering valve to the high-pressure fuel pump flows off into the line section between the shut-off valve and the metering valve). The same pressure then prevails on both sides of the metering valve and no leakage consequently occurs at the metering valve. Although the pressure drop over the shut-off valve is then relatively high, its leakage tendency is, as has already been stated, lower, and a nevertheless occurring leakage over the shut-off valve can now advantageously be compensated for by means of an above-described pressure accumulator or volume accumulator. A possible pressure drop in the line section is as a result at least considerably time-delayed.

### BRIEF DESCRIPTION OF THE DRAWING

FIG. 1 is a schematic diagram of an exemplary embodiment of the invention in a principle-illustrating arrangement of only the elements or constituent parts which are necessary for understanding the invention.

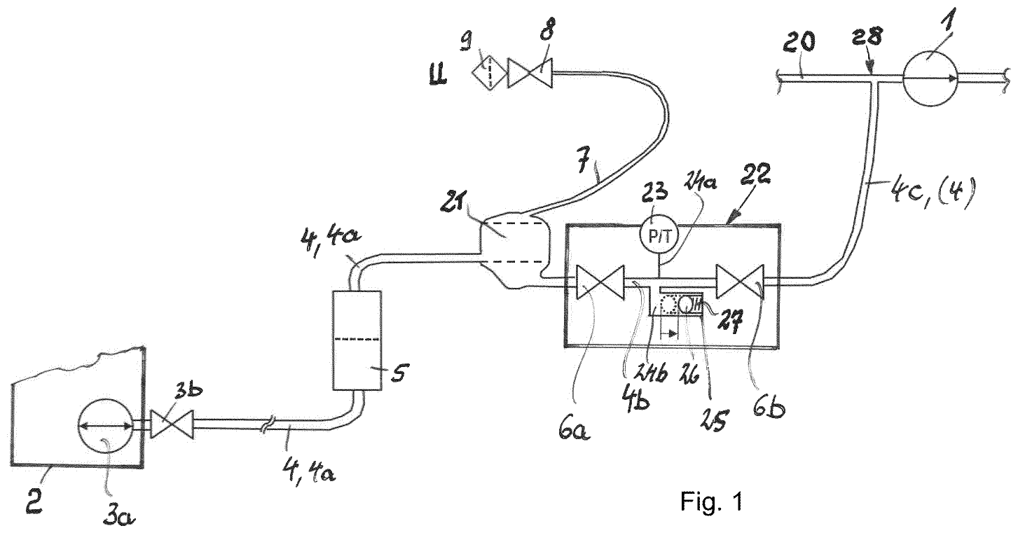

### DETAILED DESCRIPTION OF THE DRAWING

Reference number 1 denotes a high-pressure fuel pump of an internal combustion engine (not shown) which functions as a drive unit of a motor vehicle (likewise not shown). This high-pressure fuel pump 1 compresses not only the fuel which is supplied to an inlet region of the high-pressure fuel pump 1 by a fuel line 20 and which is to be supplied to the internal combustion engine after this compression, but this high-pressure fuel pump 1 can also admix water with this supplied fuel in selected operating points of the internal combustion engine. Here, the fuel passes from a fuel tank (not shown), delivered by a so-called predelivery pump (likewise not shown), through the fuel line 20 under a pressure for example in the order of magnitude of 6 bar to the inlet region of the high-pressure fuel pump 1. Provided as close as possible upstream of the high-pressure fuel pump 1 in the fuel line 20 is a line T-piece 28 for admixing water.

The water to be supplied to the high-pressure fuel pump 1 as required and in particular in dependence on the current operating point of the internal combustion engine is removed from a reservoir 2, which is carried along in the motor vehicle, by means of a delivery device 3a (=pump) whose delivery outlet is adjoined by a supply line 4 leading ultimately up to the supply device 1 or opening into the aforementioned line T-piece 28. A tank shut-off valve 3b is provided in the supply line 4 very close to the delivery device 3a and the reservoir 2. This valve is followed in the supply line 4 further downstream (as viewed in the delivery direction of the delivery device 3a) by a fine filter 5 and subsequently, already relatively close to the supply device 1, by an air separator 21. Starting from this air separator 21, the supply line 4 continues further to a so-called engine shut-off valve 6a which is assigned to the internal combustion engine and downstream of which there is arranged a metering valve 6b, starting from which the supply line 4 ultimately opens with a section 4c in the high-pressure fuel pump 1 or, more precisely, in the fuel line 20 via the line T-piece 28.

Since—as specified further above—the fuel pressure in the fuel line 20 is approximately 6 bar, a successful admixing of water should require the water pressure prevailing, with the metering valve 6b opened, at the inlet region of the high-pressure fuel pump 1, and hence also the water pressure prevailing in the section 4c of the supply line, to lie at least slightly above the fuel pressure of 6 bar.

The section of the supply line 4, or this portion of the supply line 4, leading from the tank shut-off valve 3b to the engine shut-off valve 6a is also referred to hereinbelow as section 4a, whereas the line section of the supply line 4 extending between the engine shut-off valve 6a and the metering valve 6b is also referred to as line section 4b (and prior to the description of the figure only as “line section”). Moreover, an air line branch 7 branches off from the air separator 21 and opens into the surroundings U via a venting valve 8 and a filter element 9 arranged downstream or upstream thereof.

Returning to the aforementioned line section 4b, the latter is provided in a metal body 22, which is also referred to as a metering module 22 which further comprises a receptacle for the engine shut-off valve 6a and a receptacle for the metering valve 6b. The line section 4b extends between these two valves 6a, 6b in the metal body 22, and there branches off in the metal body 22 from this line section 4b on the one hand a first branch line 24a leading to a sensor unit 23 and additionally a further branch line 24b which leads to a blind hole 25 which is provided in the metal body 22 and in which there is displaceably guided a piston 26 which is supported on the bottom of this blind hole 25 via a spring element 27. The sensor unit 23 can be used to measure the pressure and possibly also the temperature of the water situated in the line section 4b, which value or which values is or are then suitably processed by an electronic control and computing unit (not shown) which ensures correct operation of the device shown and which in particular also executes or controls an operating method presented here. In dependence on the operating state or operating point of the internal combustion engine, this electronic control and computing unit actuates the delivery device 3a, the tank shut-off valve 3b, the engine shut-off valve 6a and also the engine metering valve 6b and the venting valve 8 in a suitable manner. This occurs as described in the present documents:

With the internal combustion engine deactivated, no water should be situated in the section 4a of the supply line 4, whereas, during operation of the internal combustion engine, the supply line 4 is completely constantly filled with water under pressure or excess pressure in relation to ambient pressure that is removed from the reservoir 2. In order then to comply with this stated requirement, this section 4a of the supply line is emptied when or after deactivating the internal combustion engine, but defined pressure values are still set beforehand in different sections of the supply line 4.

Thus, at first a pressure of approximately 6 bar should prevail in the section 4c of the supply line, that is to say a pressure which corresponds to that in the fuel line 20 in order—as has already been stated further above—to ensure that the described interface between fuel and water in the section 4c remains at a distance from the metering valve 6b. With the metering valve 6b opened, this pressure can be measured by the sensor unit 23 and, if not already present, this pressure can be set by operating the delivery device 3a with the valves 3b, 6a, 6b open. A lower water pressure or pressure of water situated in the line section 4b (between the engine shut-off valve 6a and the metering valve 6b) is subsequently set in the line section. For this purpose, the metering valve 6b is closed and the shut-off valve 6a opened and, with continued opening of the tank shut-off valve 3b, where appropriate with suitable operation of the delivery device 3b, the pressure determined by the sensor unit 23 is set in the order of magnitude of for example 3 bar here. Subsequently, the shut-off valve 6a is (also) closed and (at the latest now, possibly also already when setting the pressure of 3 bar in the line section 4b) the delivery device 3a is operated with its delivery direction reversed in relation to its customary operation. Consequently, water is fed back from the section 4a of the supply line 4 into the reservoir 2. To ensure here that no appreciable negative pressure builds up in the section 4a, the aforementioned electronic control and computing unit opens the (previously closed) venting valve 8, whereby air can pass from the surroundings U via the air line branch 7 into the system or into the section 4a of the supply line 4. In order to conclude this water removal process which has been described thus far and which follows a deactivation of the internal combustion engine (for a relatively long time period) and within which process water is fed back into the reservoir 2, the tank shut-off valve 3b and the venting valve 8 are closed. The metering valve 6b is then opened for a relatively short time period. This results in pressure equalization between the line section 4b and the section 4c of the supply line 4, that is to say some water passes into the line section 4b from the section 4c situated between the metering valve 6b and the inlet region of the high-pressure fuel pump 1, and—as has been explained prior to the description of the figure—the interface between fuel and water in the section 4c is slightly displaced in the direction toward the metering valve 6b. After such pressure equalization has occurred, the metering valve 6b is also closed (again).

It is thus not possible—as has been already stated—for any ice formation to occur in the section 4a of the supply line when the motor vehicle is parked or when the internal combustion engine is deactivated under low ambient temperatures, since no water is situated in the section. Although ice formation can occur in the relatively short section 4c of the supply line, this section 4c is however not filled with water completely, namely only up to the aforementioned interface, the volume increase of which water upon ice formation is accommodated by the fuel situated in this section 4c.

And if the water situated in line section 4b and thus in the metering module 22 freezes, its volume increase is accommodated by the already explained piston 26 which can be displaced against the force of the spring element 27, that is to say that this piston 26 is displaced further into the blind hole 25 as a result of the volume increase of the water freezing in the metering module 22. This spring-loaded piston 26 in the blind hole 25 constitutes the measure provided here for the elastically deformable change in the volume of the line section 4b of the supply line 4. For this purpose, the metering module 22 is (preferably) designed with respect to targeted freezing. It is possible by suitable distribution of material (construction material) of the metering module 22, which is at least slightly capable of storing heat, to achieve a situation in which, as considered with regard to time, certain regions or sections of this metering module 22, under ambient temperatures below zero degrees Celsius, assume this ambient temperature earlier than other regions or sections. In the present case, the configuration is then such that the region or section around the blind hole 25 is the last to cool to the ambient temperature, whereas this occurs earlier in the other sections or regions. It is thereby ensured that the volume increase of the water freezing within this metering module is completely accommodated by the piston 26 displaced as a result.

Upon reactivation of the internal combustion engine it is possible, in those regions of the installation shown in the figure or of the system shown in the figure where water may indeed freeze, first of all for an electric heating device (not shown) to thaw this frozen water. Subsequently, by activating the delivery device 3a, the installation shown or the system shown can be filled with water after the tank shut-off valve 3b has been opened. Since no air must pass here to the supply device 1, the engine shut-off valve 6a remains initially closed. The delivery device 3a now delivers water in the direction of the closed engine shut-off valve 6a for such time until all air from the section 4a of the supply line has been removed via the air separator 21. The engine shut-off valve 6a can then be opened and the device can be operated as intended.

Moreover, as explained prior to the description of the figure, a displacement of the aforementioned interface in the section 4c of the supply line 4 leading from the metering valve 6b to the high-pressure fuel pump 1 can also be effected independently of an emptying of the section 4a of the supply line 4 when deactivating the internal combustion engine or parking the motor vehicle. This can in particular also be effected after each supply of water into the high-pressure fuel pump 1 in order to minimize the degree of contamination of water by components of the fuel.

1.-7. (canceled)

8. A device for supplying a liquid at risk of freezing into a high-pressure fuel pump of an internal combustion engine provided in a motor vehicle, comprising:
a metering valve by which the liquid at risk of freezing is admixed as required in a controlled manner with fuel present in an inlet region of the high-pressure fuel pump, wherein
the device is designed to return the liquid at risk of freezing at least from a portion of a supply line, through which the liquid passes from a reservoir to the high-pressure fuel pump, to the reservoir; and
a shut-off valve arranged upstream of the metering valve in the supply line as viewed in a flow direction from the reservoir to the high-pressure fuel pump, wherein
the supply line is designed to elastically deformably change its volume in a line section situated between the shut-off and metering valves.

9. The device according to claim 8, wherein
the line section of the supply line that is situated between the shut-off valve and the metering valve is designed to elastically deformably change its volume to such a degree that a volume increase occurring upon freezing of the liquid situated in the line section is accommodated by the elastic deformation.

10. The device according to claim 8, wherein
the line section between the shut-off valve and the metering valve is designed with respect to a targeted freezing such that, by virtue of higher wall thicknesses in a region producing the elastic deformation, a freezing of liquid situated in said region occurs later in time than in other regions of the line section of the supply line.

11. The device according to claim 8, wherein
the elastic deformability for volume change is formed by a wall portion of the line section of the supply line that is displaceable against a force of a spring element.

12. The device according to claim 9, wherein
the elastic deformability for volume change is formed by a wall portion of the line section of the supply line that is displaceable against a force of a spring element.

13. The device according to claim 10, wherein
the elastic deformability for volume change is formed by a wall portion of the line section of the supply line that is displaceable against a force of a spring element.

14. An operating method for a device for supplying a liquid at risk of freezing into a high-pressure fuel pump of an internal combustion engine provided in a motor vehicle, comprising:
admixing, via a metering valve, the liquid at risk of freezing as required in a controlled manner from a supply line with fuel present in an inlet region of the high-pressure fuel pump; and
after parking the motor vehicle, at least under conditions which make possible freezing of the liquid at risk of freezing, and/or subsequent to a delivery of the liquid to the high-pressure pump, opening the metering valve, with liquid pressure suitably set upstream thereof, for so long that some of the liquid situated in a section of the supply line leading from the metering valve to the high-pressure fuel pump flows off through the metering valve.

15. The operating method according to claim 14, wherein
the liquid at risk of freezing is returned at least from a portion of a supply line, through which the liquid passes from a reservoir to the high-pressure fuel pump, to the reservoir, and
at a time before said return, a certain liquid pressure lying above ambient pressure is produced in the supply line upstream of the closed metering valve, whereupon a shut-off valve, which, as viewed in the flow direction from the reservoir to the high-pressure fuel pump, is arranged upstream of the metering valve in the supply line, is closed.

16. The operating method according to claim 15, wherein
the liquid pressure produced lies in terms of magnitude below the fuel pressure prevailing at the inlet region of the high-pressure fuel pump.
